(19) United States
(12) Patent Application Publication
(10) Pub. No.: US 2026/0187743 A1
(43) Pub. Date: Jul. 2, 2026

(54) SYSTEM AND METHOD FOR AI-MEDIATED DISCOVERY, NOTIFICATION, AND LICENSED ACCESS TO COPYRIGHTED WORKS DURING RESEARCH

(71) Applicant: Adam Glen Slote, Tiburon, CA (US)

(72) Inventor: Adam Glen Slote, Tiburon, CA (US)

(21) Appl. No.: 19/541,352

(22) Filed: Feb. 16, 2026

(51) Int. Cl. G06Q 50/18; G06Q 10/0631; G06Q 20/38

(52) U.S. Cl. CPC G06Q 50/184; G06Q 10/06316; G06Q 20/38

(57) ABSTRACT

A system and method for AI-mediated discovery, notification, and licensed access to copyrighted works during a research session. The system comprises: a content registry in which copyright holders register works and grant trusted read access to authorized AI tools; a trusted content ingestion module that reads the full text of registered works and generates internal representations including semantic embeddings, structural analysis, and portion-level summaries, and generates indexing information for the content registry; an AI research tool that draws on its comprehension of registered works to identify works relevant to a user's research query and present a non-disclosive notification describing relevance and pricing; a trust boundary enforced by technical and contractual controls preventing disclosure of protected content prior to authorized payment; a transaction processing layer that processes payment from the user to the copyright holder; and a content delivery module that delivers the authorized portion within the research session.

### FIELD OF THE INVENTION

The present invention relates generally to systems and methods for digital content licensing, and more particularly to a platform that integrates artificial intelligence research tools with copyright licensing infrastructure to enable real-time identification, notification, and paid access to copyrighted works relevant to a user's research activity. The invention further relates to trusted-access arrangements in which an AI tool is granted read access to copyrighted works for the purposes of content comprehension, relevance assessment, and automated indexing, while the user does not obtain access to the copyrighted works until payment is authorized.

### BACKGROUND OF THE INVENTION

Researchers using artificial intelligence tools face a structural problem when their research touches on copyrighted works. AI tools trained on large datasets may have awareness that copyrighted works relevant to a user's query exist, but the tools cannot provide the user with access to those works without implicating copyright protections. The researcher may not know that a relevant copyrighted work exists, and even if the researcher is aware of the work, obtaining access typically requires navigating separately to a publisher's website, negotiating access terms, or subscribing to a database.

Copyright holders, for their part, face difficulty monetizing their works in the context of AI-assisted research. Existing licensing models are largely structured around bulk agreements between publishers and AI companies for model training data, or around traditional subscription models where individual users subscribe to databases or journals. There is no established system for a copyright holder to make individual works available for per-use licensed access at the point where an AI tool has identified the work as relevant to an active research session.

A further obstacle is the burden placed on copyright holders to prepare their works for discovery. Existing content marketplace and licensing systems require copyright holders to provide detailed metadata, subject matter descriptors, keyword tags, and other indexing information to enable their works to be found. For many copyright holders—particularly individual authors, small publishers, and academic researchers—the effort of preparing comprehensive indexing information is a significant barrier to participation. At the same time, the quality of recommendations that an AI tool can make to a researcher is constrained when the AI tool's knowledge of a copyrighted work is limited to metadata and abstracts rather than the full content of the work.

Several categories of prior art address portions of this problem in isolation:

Content payment systems exist that mediate micropayments between content consumers and content providers (e.g., U.S. Pat. No. 8,374,958; U.S. Patent Application Publication No. 2015/0154583). These systems handle payment mechanics but do not incorporate AI-driven content discovery or relevance assessment.

AI-powered product recommendation and payment systems exist in which an AI conversational agent identifies products relevant to a user's expressed needs and initiates payment transactions within the conversation flow (e.g., U.S. Patent Application Publication No. 2018/0183737). These systems address commercial product purchases but do not address copyright licensing for research materials.

Retrieval augmented generation (RAG) systems exist in which an AI tool retrieves relevant content from external databases to augment its responses (e.g., U.S. Patent Application Publication No. 2024/0346256). These systems retrieve and incorporate content into AI-generated responses but do not address copyright licensing, user notification of availability, or payment for access to the underlying copyrighted work. Critically, RAG systems do not distinguish between AI read access (for comprehension and relevance assessment) and user read access (which requires licensing and payment).

Content licensing marketplaces exist that enable copyright holders to set terms and receive payment for AI use of their works (e.g., Microsoft Publisher Content Marketplace). These marketplaces operate at the AI-company-to-publisher level and do not provide for individual researcher access mediated by an AI tool during an active research session.

Blockchain-based copyright revenue distribution systems exist (e.g., TWI701619B) that automate royalty payments upon copyright usage events but do not incorporate AI-mediated content discovery or researcher-facing access workflows.

No prior art identified by the applicant combines, in a single integrated system: (a) a trusted-access arrangement in which a copyright holder grants an AI tool read access to the full text of a copyrighted work for the purposes of comprehension, relevance assessment, and automated indexing, under contractual terms that prohibit the AI tool from disclosing the content to the user without payment; (b) an AI research tool that, using its comprehension of the full text of registered copyrighted works, identifies works as relevant to a user's active research query, generates an informed recommendation, and notifies the user of availability and pricing; (c) automated indexing by the AI tool that reduces or eliminates the copyright holder's burden of preparing metadata and subject matter descriptors; and (d) a transactional layer that enables the user to authorize payment and access a relevant portion of the copyrighted work within the AI research session.

### SUMMARY OF THE INVENTION

The present invention provides a system and method for AI-mediated discovery, notification, and licensed access to copyrighted works during research. The system comprises four integrated components:

A first component provides a copyright holder interface through which copyright holders register their works, define access terms (including per-use fees, subscription fees, or tiered pricing), specify which portions of works may be made available, and designate which AI tools are authorized to offer access to the works. The copyright holder may also grant trusted read access to the AI tool, enabling the AI tool to read and comprehend the full text of the work for the purposes of relevance assessment, recommendation generation, and automated indexing.

A second component provides a trusted content ingestion module through which authorized AI tools read and process the full text of registered copyrighted works under contractual terms that restrict the AI tool from disclosing the content to any user without authorized payment. The trusted content ingestion module generates internal representations of the work—including semantic embeddings, subject matter classifications, structural analysis, and portion-level summaries—that enable the AI tool to make informed relevance assessments during research sessions. The trusted content ingestion module also generates indexing information that is stored in the content registry, reducing or eliminating the copyright holder's need to manually provide metadata.

A third component provides an AI research interface that, during the course of processing a user's research query, draws on its internal representations of registered copyrighted works to identify works that are relevant to the query, generates a notification to the user indicating that one or more relevant copyrighted works are available for licensed access, and upon user authorization, delivers the relevant portion of the copyrighted work to the user within the research session.

A fourth component provides a transaction processing layer that processes payment from the user to the copyright holder (or the copyright holder's designated agent) upon the user's authorization to access a copyrighted work, records the transaction, and manages accounting between the parties.

### BRIEF DESCRIPTION OF THE DRAWINGS

FIG. 1 is a block diagram illustrating the overall system architecture of the present invention.

FIG. 2 is a flow diagram illustrating the process by which a copyright holder registers a work and defines access terms, including the trusted read-access grant.

FIG. 3 is a flow diagram illustrating the trusted content ingestion process by which the AI tool reads, comprehends, and generates internal representations and indexing information for a registered copyrighted work.

FIG. 4 is a flow diagram illustrating the process by which the AI research tool identifies relevant copyrighted works during a research session and notifies the user.

FIG. 5 is a flow diagram illustrating the transaction process from user authorization through payment settlement and content delivery.

FIG. 6 is a block diagram illustrating the data structures maintained by the content registry, including AI-generated indexing information.

FIG. 7 is a diagram illustrating the trust boundary between AI read access and user read access.

FIG. 8 is a diagram illustrating the interaction between the AI research tool, the content registry, the transaction processing layer, and the content delivery system during a representative research session.

### DETAILED DESCRIPTION OF THE INVENTION

The following description sets forth the best mode contemplated by the inventor for carrying out the invention. This description is not intended to limit the scope of the invention but rather to provide a detailed explanation of one or more embodiments.

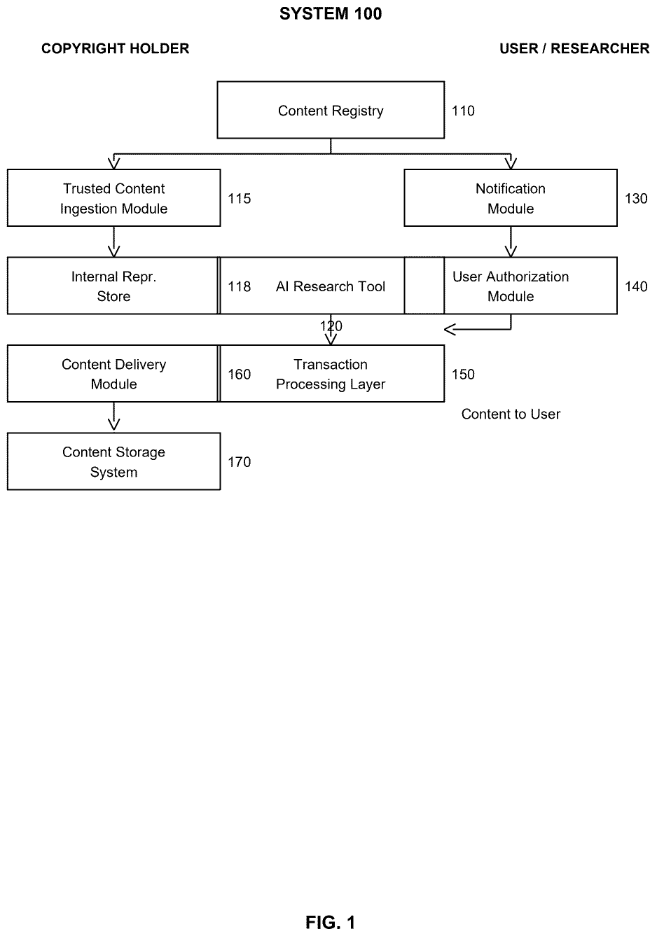

### 1. System Architecture (FIG. 1)

Referring to FIG. 1, the System 100 Comprises:

A content registry 110 that stores records of registered copyrighted works, their associated metadata (both copyright-holder-provided and AI-generated), access terms, pricing, authorized AI tool designations, trusted read-access grants, and portion availability specifications.

A trusted content ingestion module 115 that, upon receiving a trusted read-access grant from a copyright holder, reads the full text of the copyrighted work, generates internal representations of the work for use by the AI research tool 120, and generates indexing information that is stored in the content registry 110.

An AI research tool 120 that processes user research queries and, in the course of generating responses, draws on internal representations generated by the trusted content ingestion module 115 and queries the content registry 110 to identify registered copyrighted works relevant to the user's research query. The AI research tool 120 is bound by contractual and technical controls that prevent it from disclosing the content of copyrighted works to the user without authorized payment.

A notification module 130 that generates and presents to the user a notification indicating that one or more relevant copyrighted works have been identified, along with information including the title, author, a description of the relevant portion, the basis for the AI tool's relevance assessment (without disclosing protected content), and the applicable fee.

A user authorization module 140 that receives the user's decision to access or decline the identified copyrighted work and, upon authorization, initiates the transaction and content delivery processes.

A transaction processing layer 150 that processes payment from the user's account to the copyright holder's account (or to the account of the copyright holder's designated agent), records the transaction details, and generates transaction records for both parties.

A content delivery module 160 that, upon successful payment processing, retrieves the authorized portion of the copyrighted work from a content storage system 170 and delivers it to the user within the AI research session.

A content storage system 170 that securely stores the copyrighted works or portions thereof as provided by the copyright holder.

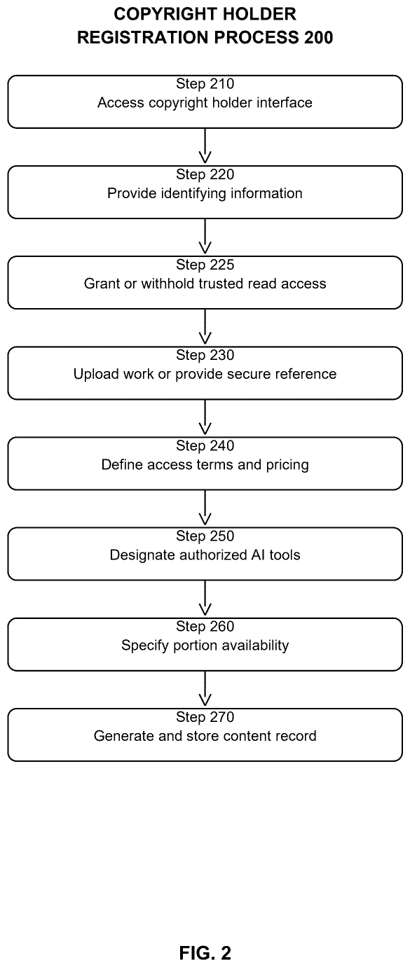

### 2. Copyright Holder Registration Process (FIG. 2)

Referring to FIG. 2, the copyright holder registration process 200 proceeds as follows:

At step 210, a copyright holder accesses the content registry 110 through a copyright holder interface. The copyright holder interface may be a web-based portal, an application programming interface (API), or a dedicated application.

At step 220, the copyright holder provides identifying information for the work to be registered, including title, author(s), publication date, and copyright registration number (if applicable). In embodiments that include trusted read access, the copyright holder may optionally provide subject matter descriptors such as keywords, classification codes, and abstracts, but is not required to do so because the trusted content ingestion module 115 will generate this information automatically.

At step 225, the copyright holder grants or withholds trusted read access. If the copyright holder grants trusted read access, the copyright holder authorizes the AI tool to read and process the full text of the work for the purposes of: (a) generating internal representations that enable the AI tool to assess the relevance of the work to user research queries; (b) generating indexing information (including subject matter descriptors, semantic embeddings, structural analysis, and portion-level summaries) that is stored in the content registry 110; and (c) generating informed recommendations to users, including descriptions of relevant portions, without disclosing the protected content itself. The trusted read-access grant is governed by contractual terms between the copyright holder and the platform operator, and by technical controls enforced by the system. The contractual terms specify that the AI tool may not: use the content of the work for model training (unless separately authorized); disclose, reproduce, or transmit the content to any user who has not authorized payment; or retain the content beyond the purposes specified in the trusted read-access grant. If the copyright holder does not grant trusted read access, the system operates using only the metadata provided by the copyright holder at step 220, as described in the original embodiment.

At step 230, the copyright holder uploads the work or designated portions thereof to the content storage system 170, or provides a secure reference (such as a URL or API endpoint) through which the content delivery module 160 can retrieve the work upon authorization.

At step 240, the copyright holder defines access terms for the work. Access terms may include one or more of: a per-use fee for a single access to a specified portion; a per-use fee for a single access to the entire work; a subscription fee providing unlimited access for a defined time period; tiered pricing based on the length or type of portion accessed; institutional pricing for users affiliated with subscribing institutions; promotional or free-access terms for specified categories of users or for specified time periods.

At step 250, the copyright holder designates which AI tools are authorized to offer access to the work. The copyright holder may authorize all participating AI tools, or may limit authorization to specified AI tools. The copyright holder may impose conditions on the AI tools, such as prohibitions on using the work for model training, restrictions on caching or storing the work beyond the duration of the research session, or requirements for attribution. The trusted read-access grant of step 225 may be limited to specified AI tools or may apply to all authorized AI tools.

At step 260, the copyright holder specifies portion availability. The copyright holder may make the entire work available, or may designate specific portions (such as chapters, sections, figures, tables, or page ranges) for individual access. The copyright holder may assign different pricing to different portions. In embodiments where trusted read access is granted, the AI tool may suggest portion boundaries and pricing tiers to the copyright holder based on its analysis of the work's structure, which the copyright holder may accept, modify, or reject.

At step 270, the content registry 110 generates a content record comprising the metadata (both copyright-holder-provided and, where applicable, AI-generated), access terms, AI tool authorizations, trusted read-access grants, and portion availability specifications, and stores the content record in the content registry database. The content registry 110 indexes the content record by subject matter descriptors to enable efficient relevance queries by the AI research tool 120.

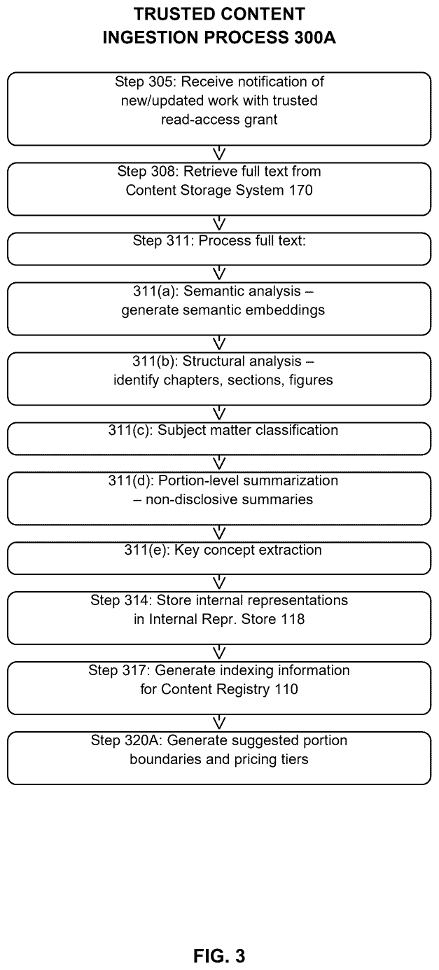

### 3. Trusted Content Ingestion Process (FIG. 3)

Referring to FIG. 3, the trusted content ingestion process 300A proceeds as follows when a copyright holder has granted trusted read access:

At step 305, the trusted content ingestion module 115 receives a notification that a new work has been registered with a trusted read-access grant, or that a previously registered work has been updated.

At step 308, the trusted content ingestion module 115 retrieves the full text of the copyrighted work from the content storage system 170 under the authority of the trusted read-access grant.

At step 311, the trusted content ingestion module 115 processes the full text of the work. Processing comprises one or more of the following:

(a) Semantic analysis: The module generates semantic embeddings representing the content of the work at the document level, section level, and paragraph level. These embeddings capture the substantive meaning of the work and enable fine-grained relevance matching against user research queries.

(b) Structural analysis: The module identifies the structural organization of the work, including chapters, sections, subsections, figures, tables, equations, and references. The structural analysis enables the system to identify discrete portions of the work that can be offered for individual access.

(c) Subject matter classification: The module classifies the work by subject matter, using taxonomies, ontologies, or classification schemes relevant to the work's domain (e.g., Medical Subject Headings for biomedical works, ACM Computing Classification System for computer science works, or general-purpose classification systems).

(d) Portion-level summarization: The module generates non-disclosive summaries of each identified portion of the work. A non-disclosive summary is a summary that describes the topic, scope, and nature of the portion in sufficient detail to enable a user to assess whether the portion is relevant to their research, without reproducing or paraphrasing the protected expression of the work. Non-disclosive summaries may describe the questions addressed, the methodology employed, and the general nature of the findings, without disclosing the specific findings, data, analysis, or expression of the work.

(e) Key concept extraction: The module identifies the key concepts, entities, methods, datasets, and findings discussed in the work and generates a structured representation of these elements for use in relevance assessment.

At step 314, the trusted content ingestion module 115 stores the generated internal representations (semantic embeddings, structural analysis, subject matter classifications, portion-level summaries, and key concept extractions) in an internal representation store 118. The internal representation store 118 is accessible to the AI research tool 120 for relevance assessment during research sessions but is not accessible to users.

At step 317, the trusted content ingestion module 115 generates indexing information for the content registry 110. The indexing information comprises subject matter descriptors, keywords, and classification codes derived from the full-text analysis. This indexing information is stored in the content record in the content registry 110, supplementing or replacing any metadata previously provided by the copyright holder. The copyright holder may review, approve, or modify the AI-generated indexing information through the copyright holder interface.

At step 320A, the trusted content ingestion module 115 optionally generates suggested portion boundaries and pricing tiers based on the structural analysis. For example, if the work is a journal article with five sections, the module may suggest offering each section as an individually accessible portion with a per-section fee, and the full article at a discounted bundled fee. These suggestions are transmitted to the copyright holder through the copyright holder interface for acceptance, modification, or rejection.

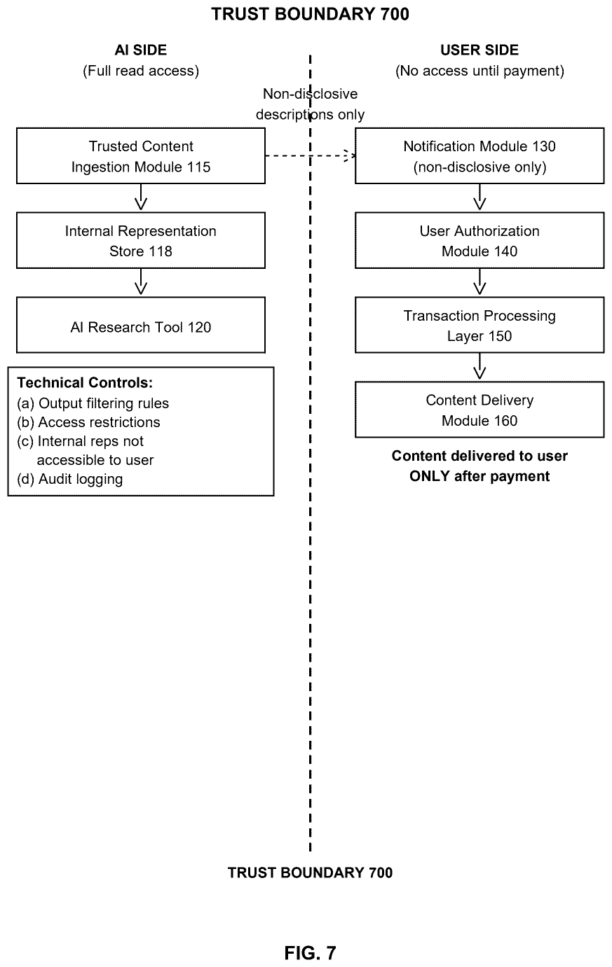

### 4. Trust Boundary Between AI Read Access and User Read Access (FIG. 7)

Referring to FIG. 7, the system enforces a trust boundary 700 between AI read access and user read access to copyrighted works.

On the AI side of the trust boundary, the trusted content ingestion module 115 and the AI research tool 120 have read access to the full text of copyrighted works for which trusted read access has been granted. This read access is used solely for the purposes specified in the trusted read-access grant: comprehension, relevance assessment, indexing, and recommendation generation.

On the user side of the trust boundary, the user does not have access to the content of any copyrighted work until the user has authorized payment and the transaction processing layer 150 has successfully processed the payment. The content delivery module 160 delivers content to the user only upon receiving an access authorization from the transaction processing layer 150.

The trust boundary is enforced by the following technical controls:

(a) The AI research tool 120 is configured with output filtering rules that prevent it from including protected content—including direct quotations, close paraphrases, specific data, specific findings, or other protected expression—in any response, notification, or communication to the user prior to authorized payment. The AI research tool 120 may include non-disclosive descriptions of the work's relevance (e.g., “This article addresses the specific enzyme variant you asked about and reports experimental results comparing its off-target activity to the wild-type enzyme”) without reproducing protected expression.

(b) The notification module 130 presents only non-disclosive information to the user: the title, author(s), publication information, AI-generated non-disclosive summaries, and pricing. The notification does not include any protected content from the work.

(c) The internal representation store 118 is not directly accessible to the user or to any user-facing interface. The internal representations are used by the AI research tool 120 only for internal relevance computations.

(d) Audit logging tracks all instances in which the AI research tool 120 accesses internal representations of copyrighted works during research sessions, enabling the platform operator and the copyright holder to verify compliance with the trusted read-access terms.

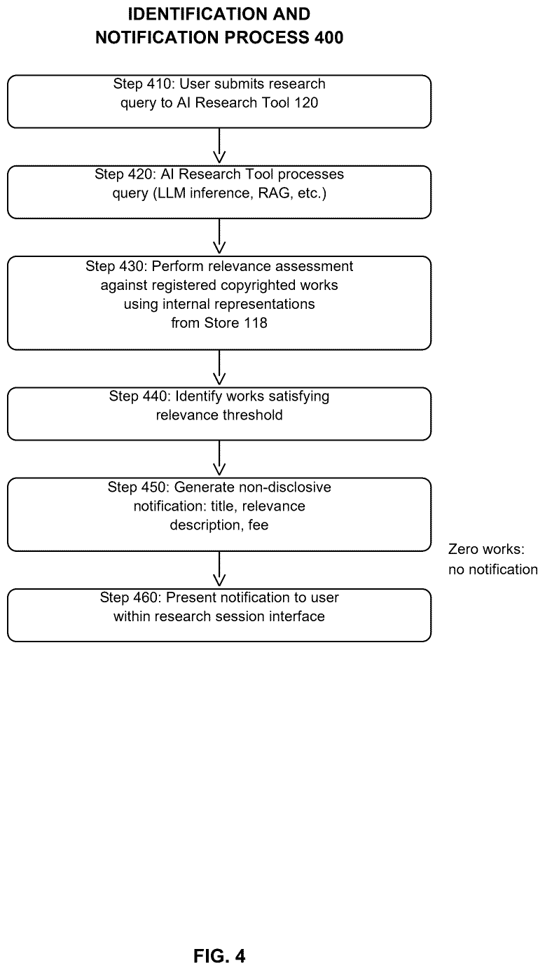

### 5. AI Research Session—Identification and Notification Process (FIG. 4)

Referring to FIG. 4, the identification and notification process 400 proceeds as follows during a research session:

At step 410, a user submits a research query to the AI research tool 120. The research query may be a natural language question, a search string, a document for analysis, or any other input that the AI research tool 120 is configured to process.

At step 420, the AI research tool 120 processes the research query using its standard query-processing capabilities (which may include large language model inference, retrieval augmented generation, or other AI techniques).

At step 430, the AI research tool 120 performs a relevance assessment against registered copyrighted works. In embodiments where trusted read access has been granted, the AI research tool 120 draws on the internal representations stored in the internal representation store 118 to perform a deep relevance assessment. The deep relevance assessment compares the semantic content of the user's research query against the semantic embeddings, key concepts, and portion-level representations of the registered copyrighted works. Because the AI research tool 120 has comprehended the full text of these works, it can assess relevance at a level of specificity and accuracy that is not possible using metadata alone. For example, the AI research tool 120 can determine not only that a work is generally about the same topic as the user's query, but that a specific section of the work addresses the specific sub-question, methodology, or dataset that the user is investigating.

In embodiments where trusted read access has not been granted, the AI research tool 120 generates a relevance query based on the user's research query and transmits the relevance query to the content registry 110, which processes the relevance query against its indexed content records using metadata-based matching, as described in the original embodiment.

At step 440, the AI research tool 120 identifies zero or more registered copyrighted works (or portions thereof) that satisfy a relevance threshold.

At step 450, the notification module 130 generates a notification to the user. In embodiments where trusted read access has been granted, the notification includes an AI-generated description of why the identified work is relevant to the user's specific query. This description is informed by the AI tool's comprehension of the full text but does not disclose protected content. For example, the notification might state: “A 2025 article in [Journal] by [Authors] includes a section that directly compares the three enzyme variants you asked about, using the same assay methodology you described. Section 4 (pp. 15-22) is available for $2.50.” The notification comprises: an indication that one or more copyrighted works relevant to the user's research query have been identified; for each identified work, the title, author(s), publication information, a non-disclosive AI-generated description of the relevant portion and the basis for the relevance assessment, and the applicable fee; an option for the user to authorize access to one or more of the identified works; and an option for the user to decline and continue the research session without accessing the identified works.

At step 460, the notification is presented to the user within the AI research session interface. The notification may be presented as an inline message, a sidebar panel, a modal dialog, or any other user interface element that preserves the context of the research session.

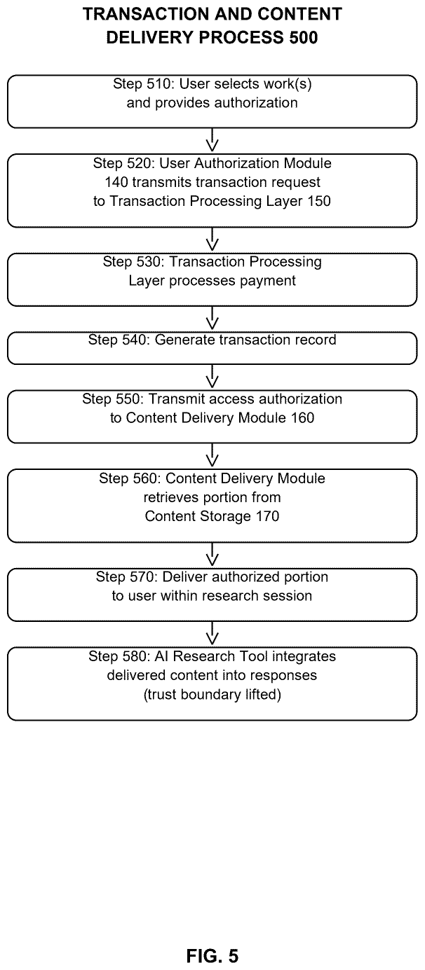

### 6. Transaction and Content Delivery Process (FIG. 5)

Referring to FIG. 5, the transaction and content delivery process 500 proceeds as follows:

At step 510, the user selects one or more identified copyrighted works for access and provides authorization. Authorization may comprise clicking an “access” button, confirming a payment prompt, or any other affirmative action. In some embodiments, the user has previously configured automatic authorization for transactions below a specified fee threshold.

At step 520, the user authorization module 140 transmits a transaction request to the transaction processing layer 150. The transaction request comprises the user's identity, the content record identifier, the portion identifier (if applicable), and the applicable fee.

At step 530, the transaction processing layer 150 processes the payment. Payment processing may involve debiting the user's prepaid account balance, charging the user's payment instrument (credit card, digital wallet, or other payment method), or applying institutional billing if the user is affiliated with a subscribing institution. The transaction processing layer 150 may deduct a platform fee before remitting the balance to the copyright holder.

At step 540, upon successful payment processing, the transaction processing layer 150 generates a transaction record comprising the transaction identifier, the user's identity (or an anonymized identifier), the content record identifier, the portion accessed, the fee paid, the timestamp, and the amounts allocated to the copyright holder and the platform operator.

At step 550, the transaction processing layer 150 transmits an access authorization to the content delivery module 160.

At step 560, the content delivery module 160 retrieves the authorized portion of the copyrighted work from the content storage system 170.

At step 570, the content delivery module 160 delivers the authorized portion to the user within the AI research session. Delivery may comprise displaying the content inline, providing a downloadable file, or presenting the content in a viewer integrated into the AI research session interface. In some embodiments, the delivered content is subject to digital rights management controls that prevent copying, redistribution, or retention beyond the research session. In other embodiments, the user receives a persistent copy for personal research use.

At step 580, the AI research tool 120 may optionally integrate information from the accessed copyrighted work into its continued processing of the user's research query, subject to any restrictions imposed by the copyright holder's access terms. Following authorized payment and delivery, the AI research tool 120 is no longer constrained by the trust boundary with respect to the delivered content and may discuss, quote, or synthesize the delivered content in its responses to the user, subject to the copyright holder's access terms.

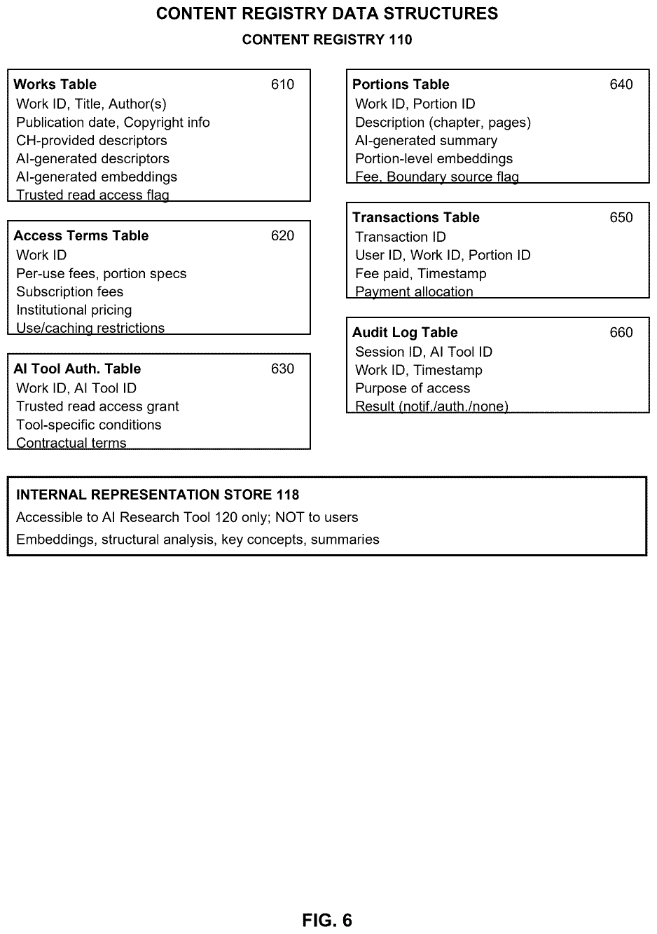

### 7. Content Registry Data Structures (FIG. 6)

Referring to FIG. 6, the content registry 110 maintains the following data structures:

A works table 610 comprising records for each registered work, each record including: a unique work identifier; title; author(s); publication date; copyright registration information; copyright-holder-provided subject matter descriptors (if any); AI-generated subject matter descriptors (if trusted read access was granted); AI-generated semantic embeddings at the document level; a reference to the stored content in the content storage system 170; a flag indicating whether trusted read access has been granted.

An access terms table 620 comprising records for each work's access terms, each record including: the work identifier; per-use fee amounts and associated portion specifications; subscription fee amounts and associated duration and scope specifications; institutional pricing terms; promotional terms; any restrictions on use, caching, or redistribution.

An AI tool authorization table 630 comprising records associating each work with authorized AI tools and trusted read-access grants, each record including: the work identifier; the AI tool identifier; whether trusted read access is granted to the AI tool; any tool-specific conditions or restrictions; contractual terms governing the trusted read access.

A portions table 640 comprising records defining the available portions of each work, each record including: the work identifier; a portion identifier; a description of the portion (e.g., chapter number, page range, section title); a non-disclosive AI-generated summary of the portion (if trusted read access was granted); AI-generated semantic embeddings at the portion level; a reference to the stored portion in the content storage system 170; the applicable fee for the portion; a flag indicating whether the portion boundary was AI-suggested or copyright-holder-specified.

An internal representation store 118 (logically associated with the content registry but accessible only to the AI research tool 120), comprising for each work with a trusted read-access grant: document-level, section-level, and paragraph-level semantic embeddings; structural analysis data; key concept and entity extractions; portion-level summaries; and any other internal representations generated by the trusted content ingestion module 115.

A transactions table 650 comprising records of completed transactions, each record including: a transaction identifier; the user identifier (or anonymized identifier); the work identifier; the portion identifier; the fee paid; the timestamp; the payment allocation (copyright holder share, platform share).

An audit log table 660 comprising records of AI tool accesses to the internal representation store 118 during research sessions, each record including: a session identifier; the AI tool identifier; the work identifier; the timestamp; the purpose of access (e.g., relevance assessment, recommendation generation); and whether the access resulted in a user notification, a user authorization, or no action.

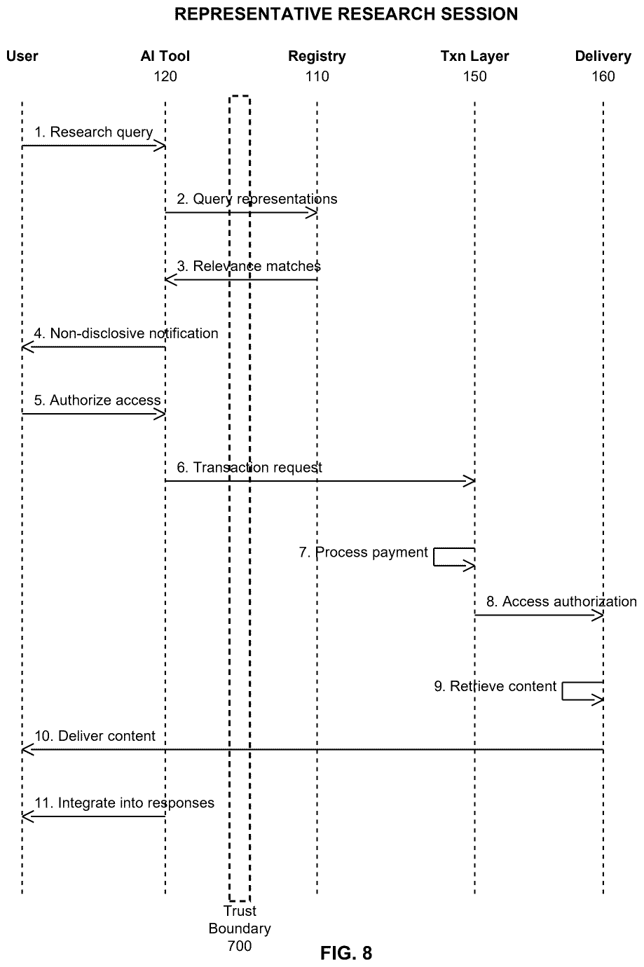

### 8. Representative Research Session (FIG. 8)

Referring to FIG. 8, a representative research session proceeds as follows:

A researcher using an AI research tool submits a query: “What are the mechanisms by which CRISPR-Cas9 off-target effects are mitigated in therapeutic applications?”

The AI research tool processes the query and generates a response based on its training data and any uncopyrighted or openly licensed sources it can access.

Concurrently, the AI research tool performs a deep relevance assessment against registered copyrighted works for which it has trusted read access. Because the AI tool has read and comprehended the full text of these works, it can assess relevance at a granular level. The AI tool determines that a recent review article published in a peer-reviewed journal contains a section that directly compares three high-fidelity Cas9 variants using the same assay methodology referenced in the researcher's query. The AI tool also determines that a second registered article reports original experimental data on guide RNA modification strategies for reducing off-target effects in a specific cell type that the researcher has mentioned in prior queries during the same session.

For works where trusted read access has not been granted, the AI research tool transmits a metadata-based relevance query to the content registry and receives results based on metadata matching.

The notification module presents a notification to the researcher within the research session:

“Two relevant articles have been identified:
1. [Title A] by [Authors], [Journal], [Date]. Section 4, ‘Comparative Analysis of High-Fidelity Cas9 Variants’ (pp. 15-22), directly compares the three variants you asked about using an in vitro cleavage assay. Available for $2.50. [Access] [Decline]
2. [Title B] by [Authors], [Journal], [Date]. This article reports original experimental data on 2′-O-methyl guide RNA modifications in HEK293T cells, which relates to the cell line you mentioned earlier. Full article available for $6.00, or Section 3 (pp. 8-14) for $2.00. [Access] [Decline].”

The researcher selects “Access” for the section of the first article. The transaction processing layer charges the researcher's account $2.50, remits $2.00 to the copyright holder's account and retains $0.50 as a platform fee.

The content delivery module retrieves the specified section and delivers it to the researcher within the research session interface.

The AI research tool, now freed from the trust boundary constraint for the delivered content, synthesizes information from the delivered section into its continued response, noting specific comparisons between the Cas9 variants and how they relate to the researcher's question.

What is claimed is:

1. A computer-implemented system for AI-mediated discovery, notification, and licensed access to copyrighted works during a research session, the system comprising:
a. a content registry stored on one or more computer-readable storage media, the content registry comprising records of copyrighted works registered by copyright holders, each record comprising metadata describing the work, access terms defining one or more fee structures for access to the work or portions thereof, and designations of one or more AI tools authorized to offer access to the work;
b. a trusted content ingestion module executed by one or more processors, the trusted content ingestion module configured to, upon receiving a trusted read-access grant from a copyright holder for a registered work, read the full text of the copyrighted work and generate internal representations of the work, the internal representations comprising one or more of: semantic embeddings, structural analysis, subject matter classifications, portion-level summaries, and key concept extractions;
c. an AI research tool executed by one or more processors, the AI research tool configured to: receive a research query from a user; process the research query; perform a relevance assessment against registered copyrighted works by drawing on the internal representations generated by the trusted content ingestion module; identify one or more registered copyrighted works satisfying a relevance threshold; and generate a non-disclosive description of why each identified work is relevant to the user's research query, the non-disclosive description being informed by the AI tool's comprehension of the full text without reproducing protected expression;
d. a notification module configured to generate and present to the user, within the research session interface, a notification indicating that one or more relevant copyrighted works are available for licensed access, the notification comprising the title, the non-disclosive relevance description, and the applicable fee for each identified work;
e. a user authorization module configured to receive the user's authorization to access one or more of the identified copyrighted works;
f. a transaction processing layer configured to process payment from the user to the copyright holder or the copyright holder's designated agent upon the user's authorization; and
g. a content delivery module configured to, upon successful payment processing, deliver the authorized portion of the copyrighted work to the user within the research session.

2. The system of claim 1, wherein the trusted content ingestion module is further configured to generate indexing information for the content registry from the full text of the copyrighted work, the indexing information comprising AI-generated subject matter descriptors, keywords, and classification codes, thereby reducing or eliminating the requirement for the copyright holder to manually provide indexing metadata.

3. The system of claim 1, wherein the trusted content ingestion module is further configured to generate suggested portion boundaries based on structural analysis of the copyrighted work, and to transmit the suggested portion boundaries to the copyright holder through a copyright holder interface for acceptance, modification, or rejection.

4. The system of claim 1, wherein the trusted content ingestion module is further configured to generate suggested pricing tiers for the suggested portion boundaries based on one or more of: the length of each portion, the structural role of each portion within the work, and comparable pricing for similar works in the content registry.

5. The system of claim 1, wherein the system enforces a trust boundary between AI read access and user read access, the trust boundary comprising:
a. output filtering rules that prevent the AI research tool from including protected expression from the copyrighted work in any communication to the user prior to authorized payment;
b. restriction of user access to the content delivery module, which delivers content only upon receiving an access authorization from the transaction processing layer; and
c. audit logging of AI tool accesses to the internal representations during research sessions.

6. The system of claim 1, wherein the AI research tool, upon delivery of the authorized portion to the user following successful payment, is permitted to discuss, quote, or synthesize the delivered content in its continued responses to the user, subject to restrictions specified in the copyright holder's access terms.

7. The system of claim 1, wherein the internal representations are stored in an internal representation store that is accessible to the AI research tool but is not accessible to any user or user-facing interface.

8. The system of claim 1, wherein the trusted read-access grant is governed by contractual terms specifying that the AI tool may not: use the content of the work for model training unless separately authorized; disclose, reproduce, or transmit the content to any user who has not authorized payment; or retain the content beyond the purposes specified in the trusted read-access grant.

9. The system of claim 1, wherein the relevance assessment performed by the AI research tool comprises comparing semantic embeddings derived from the user's research query against portion-level semantic embeddings generated by the trusted content ingestion module from the full text of the copyrighted work.

10. The system of claim 1, wherein the non-disclosive relevance description generated by the AI research tool describes the topic, scope, methodology, or nature of the identified work or portion in relation to the user's research query without disclosing specific findings, data, analysis, or protected expression.

11. The system of claim 1, wherein the access terms comprise one or more of: a per-use fee for a single access to a specified portion of the work; a per-use fee for a single access to the entire work; a subscription fee providing access for a defined time period; and tiered pricing based on the length or type of portion accessed.

12. The system of claim 1, wherein the copyright holder designates specific portions of the work for individual access and assigns different fees to different portions.

13. The system of claim 1, wherein the notification is presented as an inline element within the research session interface that preserves the context of the user's ongoing research session.

14. The system of claim 1, wherein the user has configured automatic authorization for transactions below a specified fee threshold.

15. The system of claim 1, wherein the content delivery module delivers the authorized portion subject to digital rights management controls that restrict copying, redistribution, or retention beyond the research session.

16. The system of claim 1, wherein the transaction processing layer deducts a platform fee from the payment before remitting the balance to the copyright holder.

17. A computer-implemented method for providing AI-mediated licensed access to copyrighted works during a research session, the method comprising:
a. receiving, by a trusted content ingestion module executed by one or more processors, a trusted read-access grant from a copyright holder for a copyrighted work registered in a content registry;
b. reading, by the trusted content ingestion module, the full text of the copyrighted work;
c. generating, by the trusted content ingestion module, internal representations of the copyrighted work, the internal representations comprising one or more of: semantic embeddings, structural analysis, subject matter classifications, portion-level summaries, and key concept extractions;
d. generating, by the trusted content ingestion module, indexing information for the content registry from the full text of the copyrighted work;
e. receiving, by an AI research tool executed by one or more processors, a research query from a user;
f. performing, by the AI research tool, a relevance assessment against the registered copyrighted work by drawing on the internal representations, the relevance assessment identifying the copyrighted work or a portion thereof as relevant to the user's research query;
g. generating, by the AI research tool, a non-disclosive description of why the copyrighted work or portion is relevant to the user's research query, the non-disclosive description being informed by the AI tool's comprehension of the full text without reproducing protected expression;
h. presenting, by a notification module, a notification to the user within the research session indicating that the copyrighted work or portion is available for licensed access, the notification comprising the title, the non-disclosive relevance description, and the applicable fee;
i. receiving, by a user authorization module, the user's authorization to access the copyrighted work or portion;
j. processing, by a transaction processing layer, payment from the user to the copyright holder or the copyright holder's designated agent; and
k. delivering, by a content delivery module, the authorized portion of the copyrighted work to the user within the research session upon successful payment processing.

18. The method of claim 17, further comprising: enforcing, by the system, a trust boundary between AI read access and user read access, wherein the AI research tool is prohibited from disclosing protected expression from the copyrighted work to the user prior to authorized payment.

19. The method of claim 17, further comprising: generating, by the trusted content ingestion module, suggested portion boundaries and pricing tiers based on structural analysis of the copyrighted work; and transmitting the suggested portion boundaries and pricing tiers to the copyright holder for acceptance, modification, or rejection.

20. The method of claim 17, further comprising: upon delivery of the authorized portion to the user following successful payment, permitting the AI research tool to discuss, quote, or synthesize the delivered content in its continued responses to the user, subject to restrictions specified in the copyright holder's access terms.

21. A computer-implemented system for enabling copyright holders to offer licensed access to copyrighted works through AI research tools with trusted read access, the system comprising:
a. a copyright holder interface configured to receive from a copyright holder: registration of a copyrighted work; specification of access terms comprising fee structures for access to the work or portions thereof; designation of AI tools authorized to offer access to the work; and a trusted read-access grant authorizing one or more designated AI tools to read and comprehend the full text of the work for the purposes of relevance assessment, recommendation generation, and automated indexing;
b. a trusted content ingestion module configured to, upon receiving the trusted read-access grant, read the full text of the copyrighted work and generate: internal representations for use by the authorized AI tools in relevance assessment; indexing information for the content registry, thereby reducing or eliminating the copyright holder's burden of manually providing subject matter descriptors and metadata; and suggested portion boundaries and pricing tiers based on structural analysis of the work;
c. a content registry configured to store the registered works, their access terms, AI-generated indexing information, and AI tool authorizations, and to maintain an internal representation store accessible to authorized AI tools but not to users;
d. a transaction processing layer configured to process payments from users of the authorized AI tools to the copyright holder upon user authorization to access a registered work; and
e. a reporting interface configured to provide the copyright holder with records of transactions, usage data, revenue generated, and audit logs of AI tool accesses to the copyright holder's works.

22. The system of claim 21, wherein the copyright holder interface enables the copyright holder to review, approve, or modify the AI-generated indexing information and the suggested portion boundaries before they are used by the system for relevance matching and user notifications.

23. The system of claim 21, wherein the trusted read-access grant specifies that the AI tool may not use the content of the work for model training unless the copyright holder has provided a separate authorization for model training use.

24. The system of claim 21, wherein the reporting interface provides the copyright holder with audit log data showing each instance in which an authorized AI tool accessed the internal representations of the copyright holder's work during a research session, including whether the access resulted in a user notification, a user authorization, or no action.
